(19) United States
(12) Patent Application Publication
(10) Pub. No.: US 2008/0195931 A1
(43) Pub. Date: Aug. 14, 2008

(54) Parsing of ink annotations

(75) Inventors: Sashi Raghupathy, Redmond, WA (US); Paul A. Viola, Seattle, WA (US); Michael Shilman, Seattle, WA (US); Xin Wang, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/589,028

(22) Filed: Oct. 27, 2006

(51) Int. Cl. G06F 17/00

(52) U.S. Cl. 715/230

(57) ABSTRACT

Annotation recognition and parsing is accomplished by first recognizing and grouping shapes such that relationships between the annotations and the underlying text and/or images can be determined. The recognition and grouping is followed by categorization of recognized annotations according to predefined types. The classification may be according to functionality, relation to content, and the like. In a third phase, the annotations are anchored to the underlying text or images they are found to be related to.

### BACKGROUND

One of the much sought after goals in personal information management is a digital notebook application that can simplify storage, sharing, retrieval, and manipulation of a user's notes, diagrams, web clippings, and so on. Such an application needs to be able to flexibly incorporate a wide variety of data types and deal with them reasonably. A recognition-based personal information management application becomes more powerful when ink is intelligently interpreted and given appropriate behaviors according to the type. For example, hierarchical lists in digital ink notes may be expanded and collapsed just like hierarchical lists in text-based note-taking tools.

Annotations are an important part of a user's interaction with both paper and digital documents, and can be used in numerous ways within the digital notebook application. Users annotate documents for comprehension, authoring, editing, note taking, author feedback, and so on. When annotations are recognized, they become a form of structured content that semantically decorates any of the other data types in a digital notebook application. Recognized annotations can be anchored to document content, so that the annotations can be reflowed as the document layout changes. They may be helpful in information retrieval, marking places in the document of particular interest or importance. Editing marks such as deletion or insertion can be invoked as actions on the underlying document.

Existing annotation engines typically target ink-on-document annotation and use a rule-based detection system. This usually results in low accuracy and lack of ability to handle the complexity and flexibility of real world ink annotations.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to recognizing and parsing annotations in a recognition system through shape recognition and grouping, annotation classification, annotation anchoring, and similar operations. The system may be a learning based system that employs heuristic pruning and/or knowledge of previous parsing results. Various annotation categories and properties may be defined for use in a recognition system based on a functionality, a relationship to underlying content, and the like.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an example annotated electronic document;

FIG. 2 is a block diagram of ink analysis that includes parsing and recognition;

FIG. 3A illustrates major phases in annotation analysis;

FIG. 3B illustrates an example engine stack of an ink parser according to embodiments;

FIG. 4A illustrates examples of non-actionable annotations;

FIG. 4B illustrates examples of annotation types used by an annotation engine according to some embodiments;

FIG. 5 illustrates use of ink recognition based applications in a networked system;

FIG. 6 is a block diagram of an example computing operating environment, where embodiments may be implemented; and

FIG. 7 illustrates a logic flow diagram for a process of parsing of ink annotations.

### DETAILED DESCRIPTION

As briefly described above, annotations in a recognition application may be parsed using a learning based data driven system that includes shape recognition, annotation type classification, and annotation anchoring. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

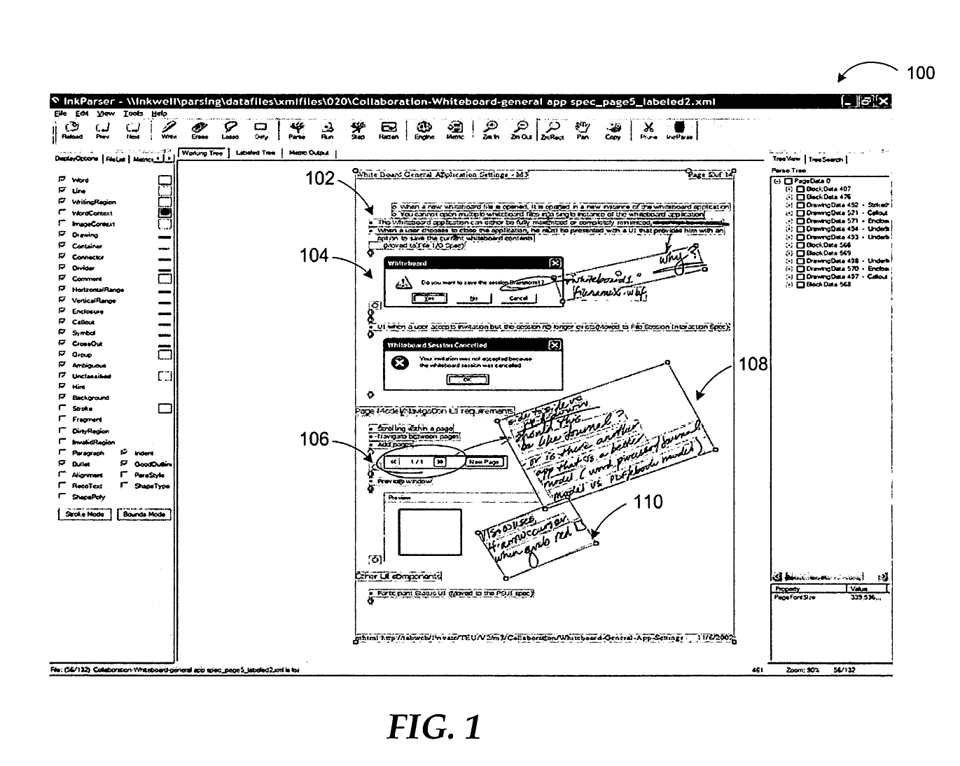

Referring to FIG. 1, an example annotated electronic document in a recognition application 100 is illustrated. The different types of annotations on the electronic document may be parsed by one or more modules of the recognition application 100, such as an annotation engine. In some embodiments, the annotation parsing functionality may be separate from the recognition application, even on a separate computing device.

Recognition application 100 may be a text editor, a word processing program, a multi-function personal information management program, and the like. Recognition application 100 typically performs (or coordinates) ink parsing operations. Ink annotation detection analysis is an important part of ink parsing. It is also crucial for intelligent editing and better inking experience for ink-based or mixed ink and text editors such as Journal®, OneNote®, and Word® by MICROSOFT CORP. of Redmond, Wash.

The electronic document in recognition application 100 includes a mixture of typed text and images (e.g. text 102, images 104 and 106). A user may annotate the electronic document by using anchored or non-anchored annotations. For example, annotation 108 is anchored by the user to a portion of image 106 through the use of a call-out circle with arrow. On the other hand, annotation 110 is a non-anchored annotation, whose relationship with the surrounding text and/or images must be determined by the annotation engine.

An annotation parsing system according to embodiments is configured to efficiently determine annotations on ink, document, and images, by recognizing and grouping shapes, determining annotation types, and anchoring the annotations before returning the parsed annotations to the recognition application. Such an annotation parsing system may be a separate module or an integrated part of an application such as recognition application 100, but it is not limited to these configurations. An annotation parsing module (engine) according to embodiments may work with any application that provides ink, document, or image information and requests parsed annotations.

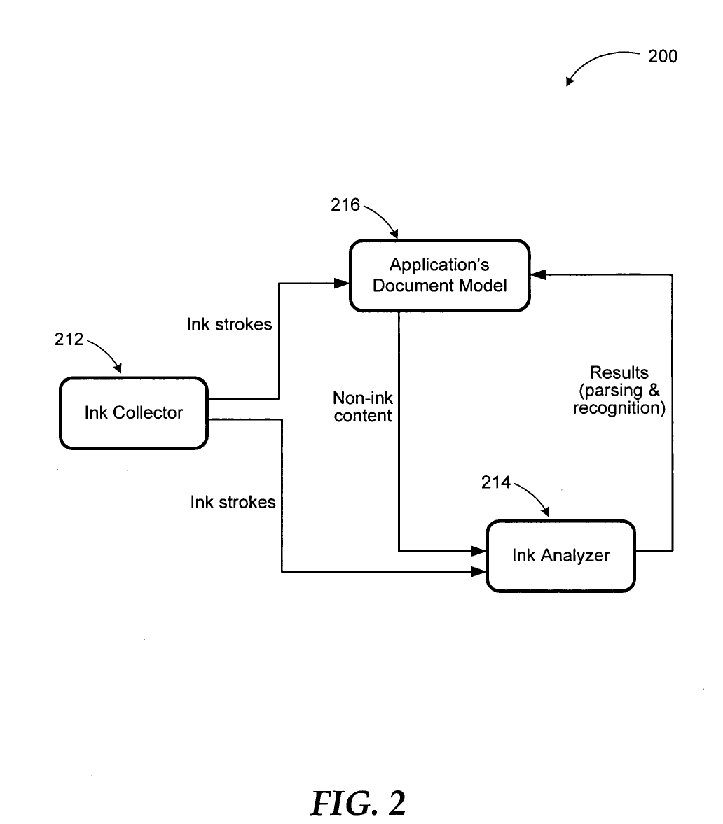

FIG. 2 is a block diagram of ink analysis that includes parsing and recognition. Diagram 200 is a top level diagram of a parsing and recognition system that may be implemented in any recognition based application. Individual modules such as ink collector 212, ink analyzer 214, and the like, may be integrated in one application or separate applications/modules.

In an operation, ink collector 212 receives user input such as handwriting with a touch-based or similar device (e.g. a pen-based device). User input is typically broken down in ink strokes. Ink collector 212 provides the ink strokes to the application's document model 216 as well as ink analyzer 214. Application's document model 216 also provides non-ink content, such as surrounding images, typed text, and the like, to the ink analyzer 214.

Ink analyzer 214 may include a number of modules tasked with analyzing different types of ink. For example, one module may be tasked with parsing and recognizing annotations. As described above, annotations are user notes on existing text, images, and the like. Upon parsing and recognizing the annotations along with accomplishing other tasks, ink analyzer 214 may provide the results to the application's document model 216.

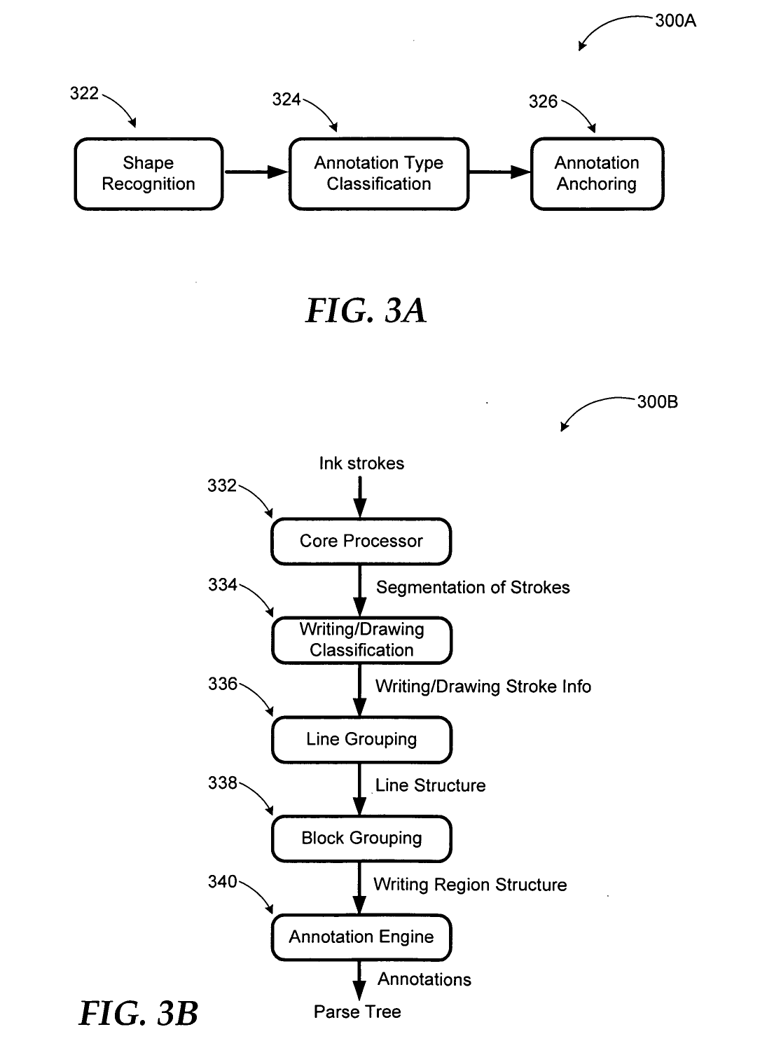

FIG. 3A illustrates major phases in annotation analysis. An annotation engine according to embodiments detects ink annotations on ink, documents, and images. The parsing system is a machine learning based data driven system. The system learns important features and classification functions from labeled data files directly, and uses the learning results to build an engine that classifies future ink annotations based on before seen examples. An annotation engine according to embodiments, is not only capable of recognizing annotations on heterogeneous data such as ink, text, images, and the like, but it can also relate connections between these heterogeneous data using annotations. For example, a callout may relate an image to an adjacent text, and the annotation engine may be capable of determining that relationship.

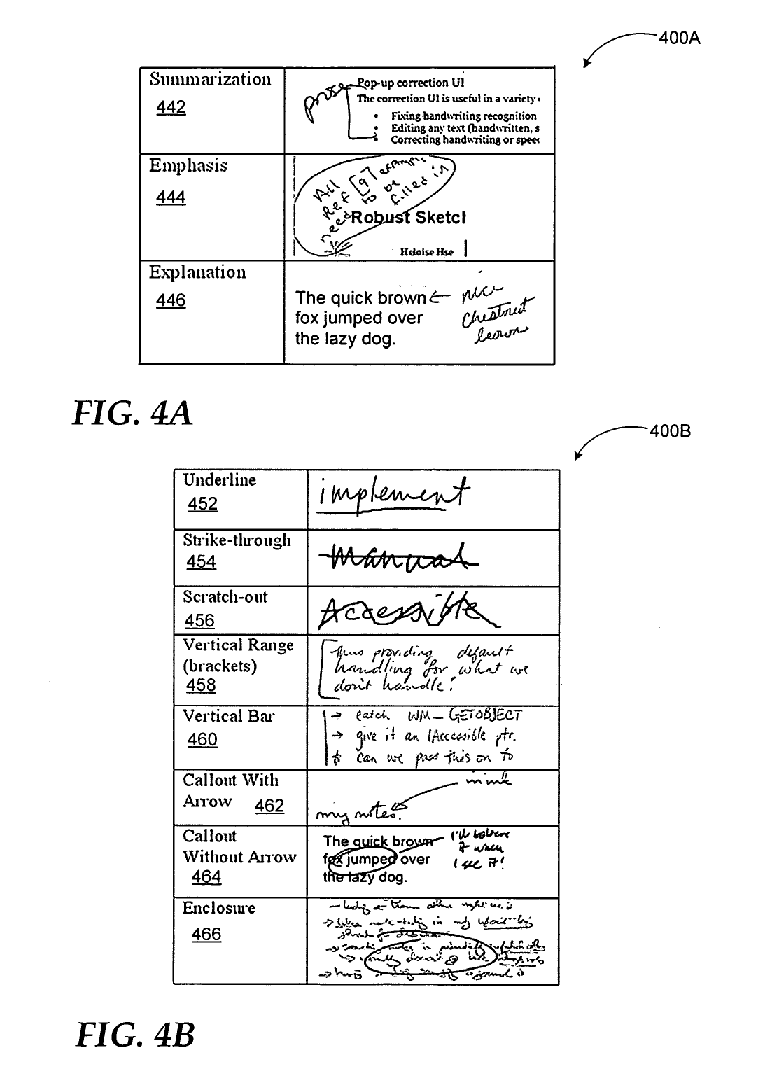

In a first phase 322, shapes are recognized and grouped such that relationships between the annotations and the text and/or images can be determined. This is followed by the second phase 324, where annotations are classified according to their types. An ink annotation on a document consists of a group of semantically and spatially related ink strokes that annotate the content of the document. Therefore, annotations may be classified in many ways including functionality, relation to content, and the like. According to some embodiments, an annotation engine may support four categories and eight types of annotation according to both the semantic and the geometric information they carry. Geometric information may include the kind of ink-strokes in the annotation, how the strokes form a geometric shape, and how the shape relates (both temporally and spatially) to other ink-strokes. The semantic information may include the meaning or the function of the annotation, and how it relates to other semantic objects in the document, e.g. words, lines, and blocks of text, or images. The four categories and eight types of annotations according to one embodiment, are discussed in more detail in conjunction with FIG. 4B.

In a third phase 326, the annotations are anchored to the text or images they are found to be related to completing the parsing operation. Regardless of the geometric shape it takes, an annotation establishes a semantic relationship among parts of a document. The parts may be regions or spans in the document, such as part of a line, a paragraph, an ink or text region, or an image. The annotation may also denote a specific position in the document such as before or after a word, on top of an image and so on. These relationships are referred to as anchors, and in addition to identifying the type of annotation for a set of strokes, the annotation parser also identifies its anchors. The phases described here may be broken down to additional operations. The phases may also be combined into fewer stages, even a single stage. Some or all of the operations covered by these three main phases may be utilized for different parsing tasks. In some cases, some operations may not be necessary due to additional information accompanying the ink strokes.

FIG. 3B illustrates an example engine stack 300B of an ink parser according to embodiments. Symbol classification and grouping techniques may be utilized in parsing annotations. First, ink strokes may be rendered into image features. Then, these image features and other heuristically designed stroke/line/background features may be provided to a classifier to learn a set of decision trees. These decision trees may then be used to classify drawing strokes in an ink or mixed ink-and-text document into annotations types. The system may also identify the context of the annotation, and create corresponding links in the parse tree data structure.

In a parser/recognizer system, a number of engines are used for various tasks. These engines may be ordered in a number of ways depending on the parser configuration, functionalities, and operational preferences (e.g. optimum efficiency, speed, processing capacity, etc.). Engine stack 300B, which is just one example according to embodiments, ink strokes are first provided to core processor 332. Core processor 332 provides segmentation of strokes to writing/drawing classification engine 334. Writing/drawing classification engine 334 classifies ink strokes as text and/or drawings and provides writing/drawing stroke information to line grouping engine 336. Line grouping engine 336 determines and provide line structure information to block grouping engine 338. Block grouping engine 338 determines block layout structure of the underlying document and provides writing region structure information to annotation engine 340.

Annotation engine 340 parses the annotations utilizing the three main phases described above in a learning based manner, and provides the parse tree to the recognition application. As one of the last engines in the engine stack, the annotation engine 340 can access the rich temporal and spatial information the other engines generated and their analysis results, in addition to the original ink, text, and image information. For example, the annotation engine 340 may use previous parsing results on ink type property of a stroke (writing/drawing). It may also use the previously parsed word, line, paragraph, and block layout structure of the underlying document. Engine stack 300B represents one example embodiment. Other engine stacks including fewer or more engines, where some of the tasks may be combined into a single engine, as well as different orders of engines may also be implemented using the principles described herein.

FIG. 4A illustrates examples of non-actionable annotations. As mentioned before, annotations may be categorized in many ways. One such method is classifying them as actionable and non-actionable annotations. Actionable annotations denote editorial actions such as insertion, deletion, transposition, or movement. Once an actionable annotation is recognized, it can be utilized to perform an actual action such as inserting a new word in between two existing words, and so on. This may happen immediately or at a later time depending on a user preference. Non-actionable annotations simply explain, summarize, emphasize, comment, and the like, on the content of the underlying document.

Table 400A provides three example non-actionable annotations. Summarization 442 may be indicated by a user in form of a bracket along one side of a portion of text to be summarized with the summary comment inserted next to the bracket. Emphasis 444 may be indicated by an asterisk and an attached comment. Finally, explanation 446 may be provided by a simple arrow pointing annotation text to a highlighted portion of the underlying text (or image).

FIG. 4B illustrates examples of annotation types used by an annotation engine according to some embodiments. As mentioned previously, four categories may be supported by an annotation engine according to embodiments: horizontal ranges, vertical ranges, enclosures, and callouts.

For horizontal ranges, three subtypes may be supported, underlines (452), strike-throughs (454), and scratch-outs (456) of different shapes. For vertical ranges, the category may be divided into two subtypes, vertical range (458) in general (brace, bracket, parentheses, and etc), and vertical bar (460) in particular (both single and double vertical bars). For callouts, straight line, curved, or elbow callouts with arrowheads (462) or without arrowheads (464) may be recognized. For enclosure (466), blobs of different shapes may be recognized: rectangle, ellipse, and other regular or irregular shapes. A system according to embodiment may even recognize partial enclosures or enclosures that overlap more than once.

Embodiments are not limited to the example annotation types discussed above. Many other types of annotations may be parsed and recognized in a system according to embodiments using the principles described herein.

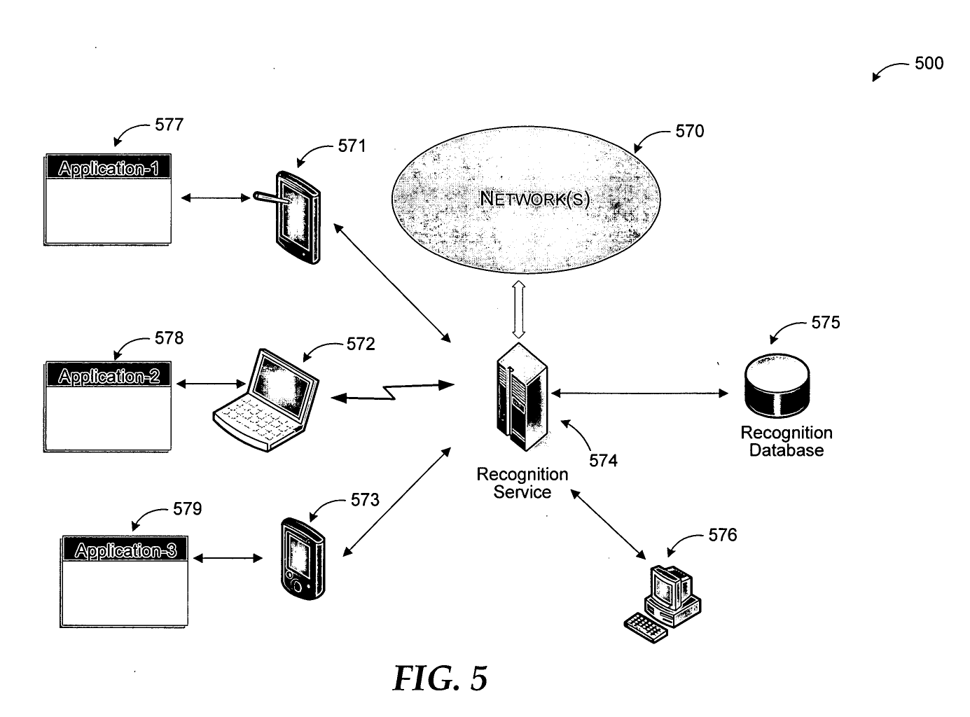

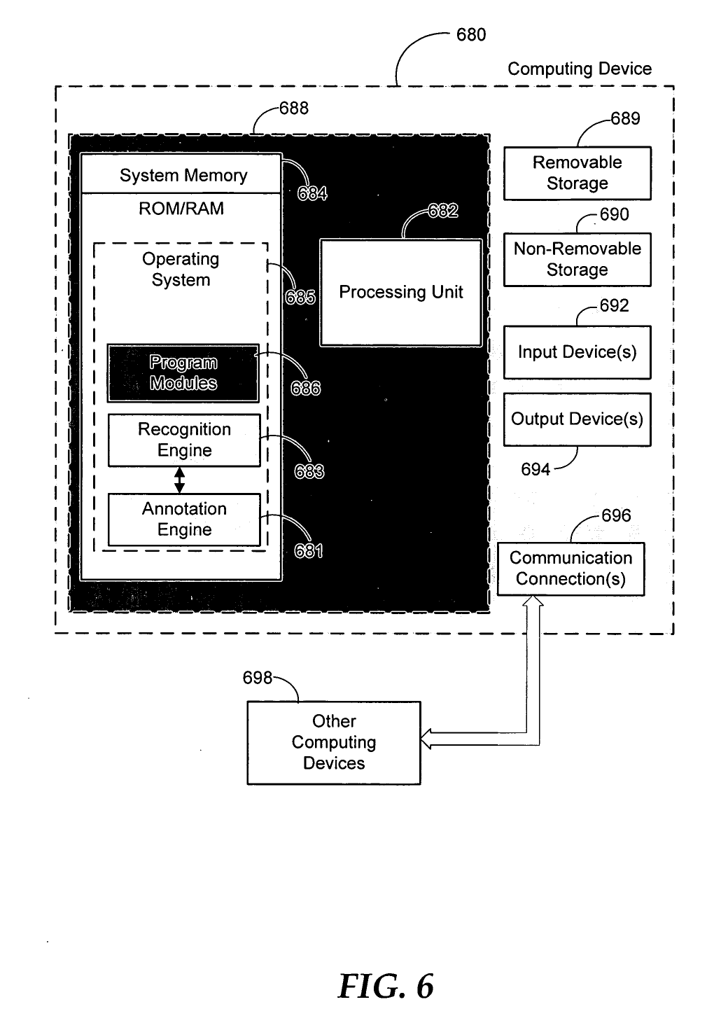

Referring now to the following figures, aspects and exemplary operating environments will be described. FIG. 5, FIG. 6, and the associated discussion are intended to provide a brief, general description of a suitable computing environment in which embodiments may be implemented.

Referring to FIG. 5, a networked system where example recognition applications may be implemented is illustrated. System 500 may comprise any topology of servers, clients, Internet service providers, and communication media. Also, system 500 may have a static or dynamic topology. The term “client” may refer to a client application or a client device employed by a user to perform operations associated with recognizing annotations. While a networked recognition and parsing system may include many more components, relevant ones are discussed in conjunction with this figure.

Recognition service 574 may also be executed on one or more servers. Similarly, recognition database 575 may include one or more data stores, such as SQL servers, databases, non multi-dimensional data sources, file compilations, data cubes, and the like.

Network(s) 570 may include a secure network such as an enterprise network, an unsecure network such as a wireless open network, or the Internet. Network(s) 570 provide communication between the nodes described herein. By way of example, and not limitation, network(s) 570 may include wired media such as a wired network or direct-wired connection, and wireless media such as acoustic, RF, infrared and other wireless media.

In an operation, a first step is to generate a hypothesis. Ideally, a hypothesis should be generated for each possible stroke grouping, annotation type, and anchor set, but this may not be feasible for a real-time system. Aggressive heuristic pruning may be adopted to parse within a system's time limits. If spatial and temporal heuristics are not sufficient to achieve acceptable recognition results, heuristics based on knowledge of previous parsing results may be utilized as well.

For stroke grouping, the set of all possible annotation stroke group candidates may be pruned greatly based on previous writing/drawing classification results. If the type of the underlying and surrounding regions of a stroke group candidate is known, its set of feasible annotation types may be limited to a subset of all annotation types supported by the system. For example, if it is known that a line segment goes from an image region to a text region, it is more likely to be a callout without arrow or a vertical range than a strike-through. Similarly, if the type of an annotation is known, the set of possible anchors may also be reduced. For a vertical range, its anchor can only be on its left or right side; for an underline, its anchor can only be above it, and the like. With carefully designed heuristics, the number of generated hypotheses may be significantly reduced.

For each enumerated hypothesis, a combined set of shape and context features may be computed. Different types of shape features may be utilized, e.g. image-based Viola-Jones filters or the more expensive features based on the geometric properties of a shape's poly-line and convex hull. Geometric features that are general enough to work across a variety of shapes and annotation types and features designed to discriminate two or more specific annotation types may be used.

The annotation engine may utilize a classifier system to evaluate each hypothesis. If the hypothesis is accepted, it can be used to generate more annotation hypotheses, or to compute features for the classification other annotation hypotheses. In the end, the annotation engine produces annotations that are grouped, typed, and anchored to their context.

The annotation engine may be a module residing on each client device 571, 572, 573, and 576 performing the annotation recognition and parsing operations for individual applications 577, 578, 579. Yet in other embodiments, the annotation engine may be part of a centralized recognition service (along with other companion engines) residing on server 574. Any time an application on a client device needs recognition, the application may access the centralized recognition service on server 574 through direct communications or via network(s) 570. In further embodiments, a portion (some of the engines) of the recognition service may reside on a central server while other portions reside on individual client devices. Recognition database 575 may store information such as previous recognition knowledge, annotation type information, and the like.

Many other configurations of computing devices, applications, data sources, data distribution and analysis systems may be employed to implement a recognition/parsing system with annotation parsing capability. Furthermore, the networked environments discussed in FIG. 5 are for illustration purposes only. Embodiments are not limited to the example applications, modules, or processes. A networked environment for implementing recognition applications with annotation parsing capability may be provided in many other ways using the principles described herein.

With reference to FIG. 6, one example system for implementing the embodiments includes a computing device, such as computing device 680. In a basic configuration, the computing device 680 typically includes at least one processing unit 682 and system memory 684. Computing device 680 may include a plurality of processing units that cooperate in executing programs. Depending on the exact configuration and type of computing device, the system memory 684 may be volatile (such as RAM), non-volatile (such as ROM, flash memory, etc.) or some combination of the two. System memory 684 typically includes an operating system 685 suitable for controlling the operation of a networked personal computer, such as the WINDOWS® operating systems from MICROSOFT CORPORATION of Redmond, Wash. The system memory 684 may also include one or more software applications such as program modules 686, annotation engine 681, and recognition engine 682.

Annotation engine 681 may work in a coordinated manner as part of a recognition system engine stack. Recognition engine 683 is an example member of such a stack. As described previously in more detail, annotation engine 681 may parse annotations by accessing temporal and spatial information generated by the other engines, as well as the original ink, text, and image information. Annotation engine 681, recognition engine 682, and any other recognition related engines may be an integrated part of a recognition application or operate remotely and communicate with the recognition application and with other applications running on computing device 680 or on other devices. Furthermore, annotation engine 681 and recognition engine 682 may be executed in an operating system other than operating system 685. This basic configuration is illustrated in FIG. 6 by those components within dashed line 688.

The computing device 680 may have additional features or functionality. For example, the computing device 680 may also include additional data storage devices (removable and/or non-removable) such as, for example, magnetic disks, optical disks, or tape. Such additional storage is illustrated in FIG. 6 by removable storage 689 and non-removable storage 690. Computer storage media may include volatile and nonvolatile, removable and non-removable media implemented in any method or technology for storage of information, such as computer readable instructions, data structures, program modules, or other data. System memory 684, removable storage 689 and non-removable storage 690 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 680. Any such computer storage media may be part of device 680. Computing device 680 may also have input device(s) 692 such as keyboard, mouse, pen, voice input device, touch input device, etc. Output device(s) 694 such as a display, speakers, printer, etc. may also be included. These devices are well known in the art and need not be discussed at length here.

The computing device 680 may also contain communication connections 696 that allow the device to communicate with other computing devices 698, such as over a network in a distributed computing environment, for example, an intranet or the Internet. Communication connection 696 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

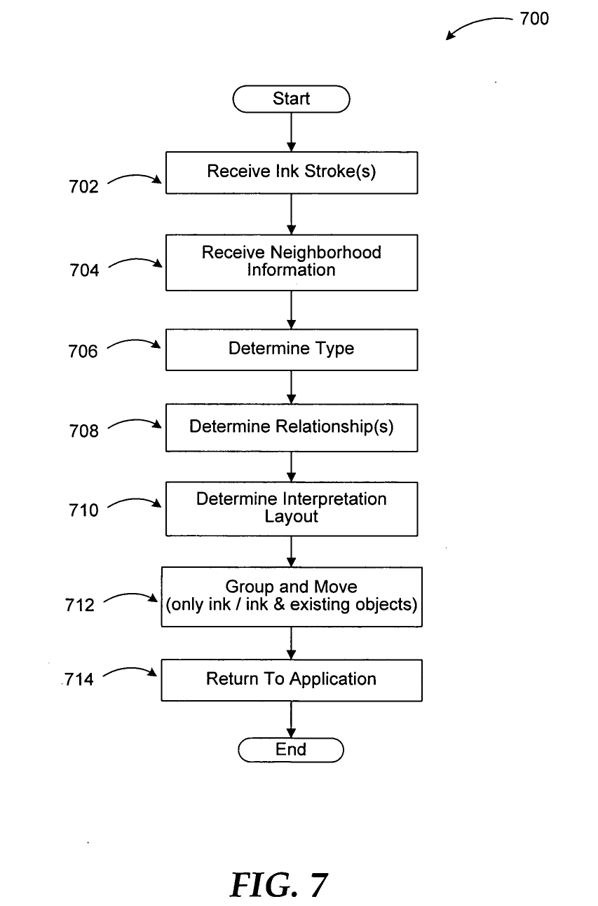

FIG. 7 illustrates a logic flow diagram for a process of parsing of ink annotations. Process 700 may be implemented in a recognition application such as applications 577, 578, or 579 of FIG. 5.

Process 700 begins with operation 702, where one or more ink strokes are received from an ink collector module. The ink strokes may be converted to image features by the a separate module or by the annotation engine performing the annotation recognition and parsing. Processing advances from operation 702 to operation 704.

At operation 704, neighborhood information is received. Neighborhood information typically includes underlying content such as text, images, and any other ink structure such as handwritten text, callouts, and the like, in the vicinity of the annotation, but it may also include additional information associated with the document. Processing proceeds from operation 704 to operation 706.

At operation 706, a type of the annotation is determined based on a semantic and geometric information associated with the ink strokes. As described previously, annotations may be classified in a number of predefined categories. The categorization assists in determining a location and structure of the annotation. Processing moves from operation 706 to operation 708.

At operation 708, one or more relationships of the annotation to the underlying content are determined. For example, the annotation may be a call-out associated with a word in the document. Processing advances from operation 708 to operation 710.

At operation 710, an interpretational layout of the annotation is determined. This is the phase where the parsed annotation is tied to the underlying document, whether a portion of the content or a content-independent location of the document. Processing advances from operation 710 to operation 712.

At operation 712, grouping and moving information for the annotation and associated underlying content (or document) is generated. The information may be used by the recognizing application to group and move the annotation with its related location in the document when handwriting is integrated into the document. Processing advances from operation 712 to operation 714.

At operation 714, the recognized and parsed annotation is returned to the recognizing application. At this point, the recognition results may also be stored for future recognition processes. For example, recognized annotations may become a form of structured content that semantically decorates any of the other data types in a digital notebook. They can be used as a tool in information retrieval. After operation 714, processing moves to a calling process for further actions.

The operations included in process 700 are for illustration purposes. Providing annotation parsing in a recognition application may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for recognizing annotations in a document, the method comprising:
receiving ink strokes associated with an annotation in the document;
receiving information associated with underlying content of the document;
determining a type of the annotation;
determining an interpretative layout of the annotation in relation to the underlying content; and
anchoring the annotation.

2. The method of claim 1, further comprising:
returning the annotation information to an application processing the document such that the recognized annotation is integrated into the content of the document.

3. The method of claim 1, further comprising:
rendering the received ink strokes into image features; and
employing one or more decision trees based on the rendered image features and the underlying content to determine the type of the annotation.

4. The method of claim 3, further comprising:
receiving data for at least one from a set of: temporal information associated with the ink strokes, spatial information associated with the ink strokes, and previous parsing results; and
employing the received data to form the one or more decision trees.

5. The method of claim 4, further comprising:
employing at least one heuristic pruning technique to reduce the one or more decision trees.

6. The method of claim 1, wherein the underlying content includes at least one of an image, an ink structure, and text.

7. The method of claim 1, wherein the underlying content is limited to a predefined vicinity of the received ink strokes.

8. The method of claim 1, wherein the type of the annotation is one from a predefined set of: an underline, a strike-through, a scratch-out, a vertical range, a vertical bar, a callout and an enclosure.

9. The method of claim 1, wherein the type of the annotation is one from a predefined set of: an explanation, a summarization, a comment, and an emphasis.

10. The method of claim 1, wherein anchoring the annotation includes establishing a relationship between the recognized annotation and a portion of the underlying content.

11. The method of claim 10, wherein anchoring the annotation further includes establishing a relationship between the recognized annotation and a location within the document.

12. A computer-readable medium having computer executable instructions for recognizing annotations in a document, the instructions comprising:
receiving ink strokes associated with an annotation in the document;
receiving information associated with underlying content of the document;
generating a hypothesis for each possible combination of an ink stroke grouping, an annotation type, and an annotation anchor;
pruning the hypotheses employing at least one of a temporal and a spatial heuristic technique;
determining a type and anchor of the annotation based on a result of the pruning.

13. The computer-readable medium of claim 12, wherein the instructions further comprise:
pruning the hypotheses employing a heuristic technique based on a knowledge of previous parsing results.

14. The computer-readable medium of claim 12, wherein the instructions further comprise:
determining a type of the annotation based on a semantic and a geometric attribute of the annotation.

15. The computer-readable medium of claim 14, wherein the geometric attribute includes a temporal and a spatial characteristic of the annotation, and wherein the semantic attribute includes a function of the annotation and a relation of the annotation to the underlying content.

16. A system for recognizing annotations in a document, comprising:
a recognizer application configured to:
receive user input for a document that includes underlying content;
determine a temporal and a spatial characteristic of ink strokes associated with the user input;
provide the ink strokes along with their characteristics; and
an annotation engine configured to:
receive the ink strokes and associated characteristic information;
receive information associated with underlying content of the document;
determine a type of the annotation;
determine a layout of the annotation in relation to the underlying content; and
anchor the annotation.

17. The system of claim 16, further comprising:
a writing-drawing classification engine configured to classify the ink strokes as one of text and a drawing;
a line grouping engine configured to determine and provide information associated with a line structure; and
a block grouping engine configured to determine a block layout structure of the underlying content and provide information associated with a writing region structure to the annotation engine.

18. The system of claim 16, wherein the annotation engine is further configure to provide grouping and moving information to the recognizer application such that the recognizer application integrates the recognized annotation into the underlying content.

19. The system of claim 16, wherein the annotation engine is further configured to determine the type and the layout of the annotation by heuristically pruning one or more decision trees that correspond to hypotheses for each possible combination of the an stroke grouping, the annotation type, and the annotation anchor.

20. The system of claim 16, wherein the annotation engine is integrated into the recognizer application.
